(19) United States
(12) Patent Application Publication
(10) Pub. No.: US 2007/0024877 A1
(43) Pub. Date: Feb. 1, 2007

(54) Method and program for teaching color existence for color-sense abnormal person, and color name information acquisition system

(75) Inventors: Hiroshi Osumi, Shizuoka-shi (JP); Mitsuaki Katsuya, Susono-shi (JP); Hiroshi Fukuda, Shizuoka-shi (JP); Shogo Uematsu, Shizuoka-shi (JP); Atsushi Murakami, Shizuoka-shi (JP); Isao Ishimoto, Shizuoka-shi (JP); Shuji Hirai, Yaizu-shi (JP)

Correspondence Address: OLIFF & BERRIDGE, PLC, P.O. BOX 19928, ALEXANDRIA, VA, 22320, US

(73) Assignee: Hiroshi OSUMI, Shizuoka-shi, Shizuoka (JP)

(21) Appl. No.: 10/558,680

(22) PCT Filed: Jun. 8, 2004
(86) PCT No.: PCT/JP04/08306

§ 371 Date: Dec. 12, 2005

(30) Foreign Application Priority Data
Jun. 12, 2003 (JP) 2003-167478
Jun. 1, 2004 (JP) 2004-163480

(51) Int. Cl. G06K 9/00; G06F 15/00

(52) U.S. Cl. 358/1.9; 358/3.01; 382/167

(57) ABSTRACT

A co-punctual center color (such as co-punctual point PTD) is set from a color which cannot be seen or is hardly seen. A gray scale gradation value corresponding to a color difference of the color of the pixel for the co-punctual center color is calculated on pixel unit form the color original image and a gray scale is created. According to this gray scale, a gray scale image or a gradation image of the similar color is created and displayed. Alternatively, a color name of the point specified in the color original image is displayed. By executing the processing by using a camera-equipped mobile telephone, a color-sense abnormal person can identify the color which he/see cannot correctly see and know the color name without feeling any constraint.

### TECHNICAL FIELD

The present invention relates to a method which reduces a color-sense barrier for color-sense abnormal persons, and a program that causes a computer to execute the method. Moreover, the present invention relates to a system, a program, and a method which acquire color name information, and tell a color name.

### BACKGROUND ART

The color sense is roughly categorized into the dichromatism and the trichromatism. The dichromatism refers to so-called color blindness. The trichromatism is further divided into the normal trichromatism and the anomalous trichromatism, and the anomalous trichromatism refers to so-called partial color blindness. The dichromatism/anomalous trichromatism are further divided into the protanopia/protanomaly, deuteranopia/deuteranomaly, and tritanopia/tritanomaly.

With reference to a u′v′ chromaticity diagram in FIG. 1, a protan, for example, views all colors upon a line (P1, P2, and P3, for example) passing a fixed point P (which is close to R) referred to as a co-punctual point, the same color, namely a confusion color.

A deutan views all colors upon a line passing a fixed point D (which is close to G), referred to as a co-punctual point, the same color, namely a confusion color, and a tritan views all colors upon a line passing a fixed point T (which is close to B) referred to as a co-punctual point, the same color, namely a confusion color.

If a viewer can sense a color even slightly, it is possible to increase a quantity of color light hard to sense, or inversely to reduce a quantity of color light easy to sense. Actually, there has been developed a color-sense correction glasses which utilizes the principle to reduce the quantity of the color light. However, especially for the dichromatic anomaly, a protanope/deuteranope, for example, hardly sees colors with wavelengths close to red/green. Thus, even if the color-sense abnormal person of this type wears the color-sense correction glasses, there is not provided the correction effect.

Moreover, some persons may feel troublesome to wear the glasses.

Further, when a person sees an object, a scenery, or the like, he may make an oral statement using a color name such as “that light pink . . . ”. In this case, if a person, whose color sense is abnormal, hears that, the person cannot visually discriminate the color.

Thus, if the person wants to know correctly the color name on the spot, the person may ask to repeat the color name, and inevitably reveals that the person is partially color blind or color blind. This disclosure often results in mental anguish.

### DISCLOSURE OF THE INVENTION

In view of the foregoing problem, the inventor has found out that if a color which cannot be seen or hardly seen by the protan, deutan, and tritan is set as a co-punctual center color, and a color actually viewable is taught as a gray scale image or a gradation image of a similar color representing a color difference of the actually viewable color from the co-punctual center color, colors can be easily distinguished by them, and proposes the following invention.

Moreover, portable terminals represented by camera-equipped portable phones have recently become explosively common. The portable phone is a type of a portable computer, and if a person can employ the portable phone to know a color name on the spot without being recognized by persons around, the person can positively contact other persons without fear of the mental anguish even if the person has an abnormality in the color sense.

Therefore, an object of the present invention is to provide a color name information acquisition system, a color name information acquisition program, and a color name information acquisition method which utilize a camera-equipped portable computer to acoustically and/or visually provide a color name on the spot.

An invention according to claim 1 provides a method for teaching a color for a color-sense abnormal person, characterized in that a gray scale image or a gradation image of a similar color of respective pixels of an original image is visually taught, or a color name at an interesting color name point upon the original image is visually or acoustically taught.

An invention according to claim 2 provides a method for teaching a color existence for a color-sense abnormal person, characterized by comprising a gray scale creating step of setting a color which a color-sense abnormal person tends to confuse or a co-punctual point to a co-punctual center color, defining a degree of confusion as a color difference between a color of each pixel of an original image and the co-punctual center color, and converting the color to a gray scale tone value which corresponds to the color difference, and is distinguished by the color-sense abnormal person, and a display step of creating and displaying a gray scale image or a gradation image of a similar color based upon the created gray scale.

An invention according to claim 3 provides the method for teaching a color existence for a color-sense abnormal person according to claim 2, characterized in that the gray scale creating step uses RGB values, sets any of the R value, the G value, and the B value as the co-punctual center color, and sets the gray scale tone value corresponding to the color difference in the RGB value between the pixel and the set co-punctual center color.

An invention according to claim 4 provides the method for teaching a color existence for a color-sense abnormal person according to claim 2, characterized in that the gray scale creating step uses a chromaticity diagram plane, sets any of fixed points P, D, and T of co-punctual points as the co-punctual center color, and sets a distance from the set co-punctual center color to the color of the pixel in the original image as the color difference.

An invention according to claim 5 provides the method for teaching a color existence for a color-sense abnormal person according to claim 4, characterized in that the gray scale creating step creates the gray scale for the tone value on the basis of a maximum display area of R, G, and B of the chromaticity diagram corresponding to a device to be used.

An invention according to claim 6 provides the method for teaching a color existence for a color-sense abnormal person according to any of claims 2 to 5, characterized in that the display step compounds the original image and the gray scale image or the gradation image into a predetermined pattern for the respective pixels, and displays a composite image.

An invention according to claim 7 provides the method for teaching a color existence for a color-sense abnormal person according to claim 6, characterized in that the display is carried out as a composite image to which optimization is applied in order to reduce a sense of discomfort for a color-sense normal person.

An invention according to claim 8 provides the method for teaching a color existence for a color-sense abnormal person according to claim 7, characterized in that the created gray scale is binarized by a pseudo halftone display technique, and the display is carried out as the composite image to which the optimization is applied by replacing a pixel of either of the values with a pixel in the original image at the same position.

An invention according to claim 9 provides the method for teaching a color existence for a color-sense abnormal person according to any of claims 2 to 8, characterized in that the display step carries out the display as a still image.

An invention according to claim 10 provides the method for teaching a color existence for a color-sense abnormal person according to any of claims 2 to 5, characterized in that the display step uses a display, and carries out a flash display of the gray scale image or the gradation image of the similar color while the original image is being displayed.

An invention according to claim 11 provides a program for teaching a color existence for a color-sense abnormal person causing a computer to execute the gray scale creating step and the display step according to any of claims 2 to 10.

An invention according to claim 12 provides the program for teaching a color existence for a color-sense abnormal person according to claim 11, characterized in that the computer is a camera-equipped portable terminal, and is caused to execute an original image acquiring step of acquiring the original image by means of imaging using a camera.

According to the method for teaching a color existence of the present invention, even a color-sense abnormal person can distinguish a confusion color.

An invention according to claim 13 provides a color name information acquisition system that utilizes a camera-equipped portable computer device, comprising point specifying means that specifies a point of an interesting color name upon a color image displayed upon a screen, color name searching means that searches for the color name of the specified point, and color name teaching means that teaches the color name with a display and/or a sound, characterized in that a user can visually and/or acoustically know the color name.

An invention according to claim 14 provides the color name information acquisition system according to claim 13, characterized by further comprising color correcting means that applies a color correction adapted to respective portable computer devices to be used to the color image.

An invention according to claim 15 provides the color name information acquisition system according to claim 13 or 14, characterized in that the color name searching means comprises color model converting means that calculates a coordinate value within a uniform color space from RGB data of the specified point, color name coordinate value searching means that searches for a color name coordinate value which is shortest in distance from the calculated coordinate value, and color name information acquiring means that acquires teaching information upon the color name from the searched color name coordinate value.

An invention according to claim 16 provides the color name information acquisition system according to any of claims 13 to 15, characterized in that the point specifying means comprises composite image creating means that creates and displays a composite image of a movable or fixed mark and the color image, and point determining means that specifies a display point of the mark as “the point of the interesting color name”.

An invention according to claim 17 provides the color name information acquisition system according to any of claims 13 to 16, characterized by comprising teaching screen creating means as the color name teaching means that creates a screen used to visually teach a color specification.

An invention according to claim 18 provides the color name information acquisition system according to any of claims 13 to 17, characterized in that the portable computer device is equipped with a camera.

An invention according to claim 19 provides a color name information acquisition program that realizes the respective means of the color name information acquisition system according to any of claims 13 to 18 as functions.

An invention according to claim 20 provides a color name information acquisition method that utilizes a camera-equipped portable computer device, comprising a point specifying step of specifying a point of an interesting color name upon a color image displayed upon a screen, a color name searching step of searching for the color name of the specified point, and a color name teaching step of teaching the color name with a display and/or a sound, characterized in that a user can visually and/or acoustically know the color name.

### BRIEF DESCRIPTION OF THE DRAWINGS

FIG. 1 is a u′v′ chromaticity diagram plane;

FIG. 2 is a flowchart of a gray scale creating process utilizing R, G, and B values;

FIG. 3 is a flowchart of a gray scale creating process utilizing a chromaticity diagram plane;

FIG. 4 is a descriptive view of the gray scale creating process utilizing the u′v′ chromaticity diagram plane;

FIG. 5 shows an original image and a hue-converted image thereof,

FIG. 6 is a descriptive view of a creating method of a superimposed composite image;

FIG. 7 is a flowchart for a binarizing process utilizing the error diffusion method;

FIG. 8 is a descriptive view of a creating method of a first checkered-pattern composite image;

FIG. 9 is a descriptive view of a creating method of second checkered-pattern composite images;

FIG. 10(1) is an Ishihara color blind test plate as an original image, and FIG. 10(2) is an example of how a deutan views;

FIG. 11 shows various gray scale images created from FIG. 10(1) as an original image;

FIG. 12 shows various composite images created from FIG. 10(1) as an original image by means of the methods in FIGS. 6 and 8;

FIG. 13 shows various composite images created from FIG. 10(1) as an original image by means of the method in FIG. 9;

FIG. 14 is a hardware configuration diagram of a camera-equipped portable phone;

FIG. 15 is an execution flowchart of a teaching program;

FIG. 16 is a block diagram showing a physical configuration of a camera-functioning portable phone which can realize a color name information acquisition system;

FIG. 17 is a block diagram showing a logical configuration of the color name information acquisition system;

FIG. 18 is a view showing an example of a display screen of a composite image;

FIG. 19 is a view showing contents of a color name data file;

FIG. 20 is a view showing a screen with color names; and

FIG. 21 is a processing flow chart.

### BEST MODE FOR CARRYING OUT THE INVENTION

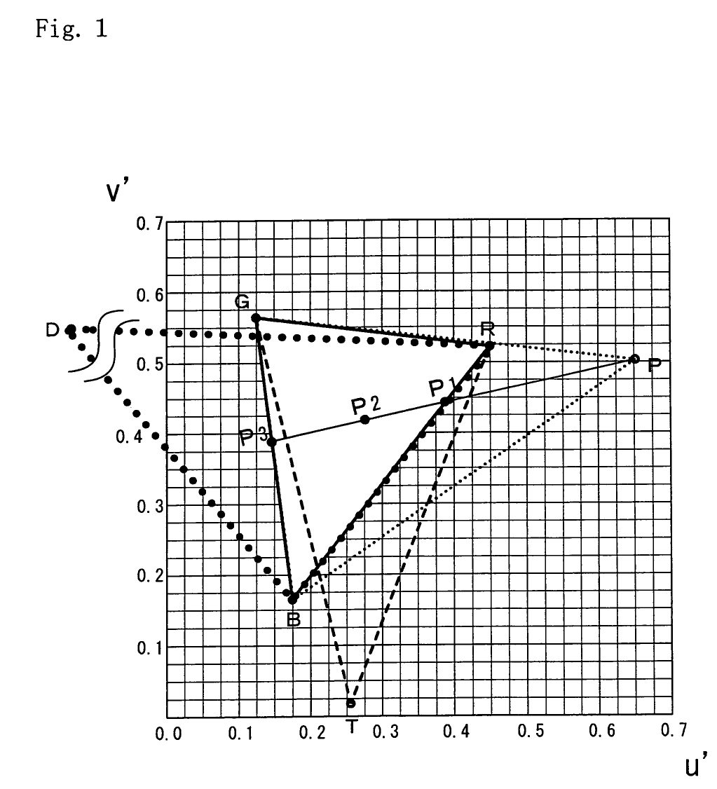

A description will now be given of a teaching method of a color existence according to an embodiment of the present invention with reference to FIGS. 1 to 15.

The description will be given respectively of an original image acquiring process, a gray scale creating process, and a display process.

In the original image acquiring process, although an original image may be a printed image, when the gray scale creating process and the display process are executed by a computer and a printer, the original image is to be acquired as electronic data.

If the original image is acquired as electronic data, the original image may be acquired by a digital camera, is read from a printed image by a scanner, or is created as a color image by means of a so-called drawing software program or the like.

A description will now be given of a gray scale creating process.

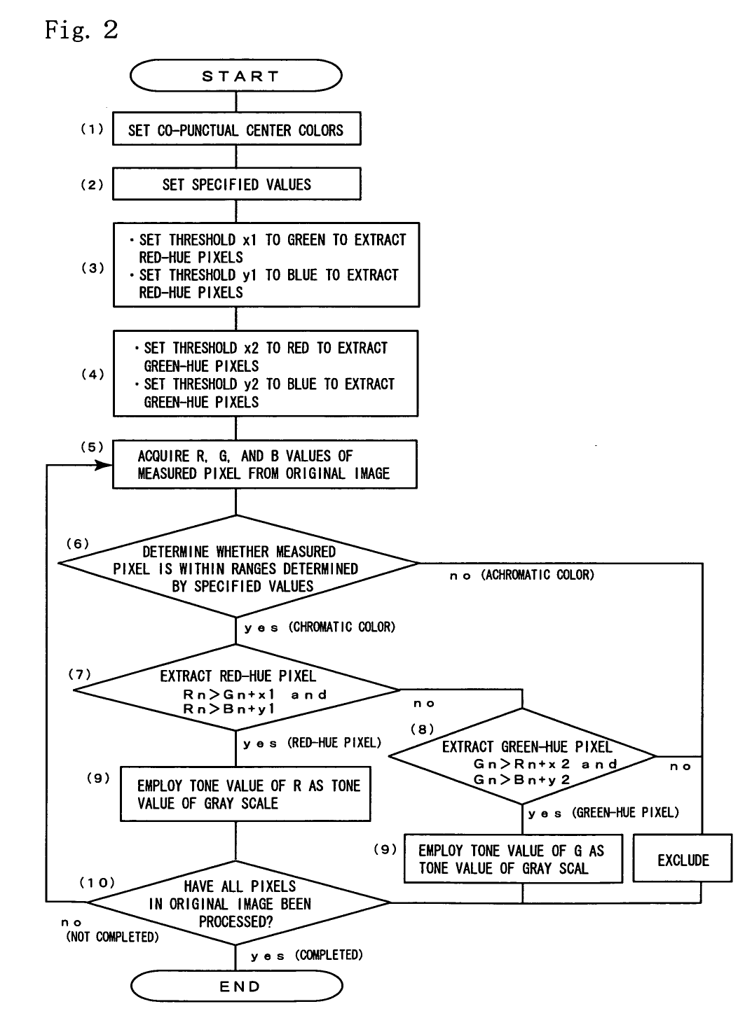

A. Utilizing R, G, and B Values (FIG. 2)

(1) Co-punctual center colors are set.

R is set as a co-punctual center color for the protan, and G is set as a co-punctual center color for the deutan. In the present embodiment, R and G are set to the co-punctual center colors.

It should be noted that arbitrary one or two colors from the three colors: R, G, and B can theoretically be set as the co-punctual center colors.

(2) Specified values are set.

It is determined whether even any one of an R value, a B value, and a G value in an original image is within a specified range of a lower to an upper limit values, and if a result of the determination is negative, the color is classified as an exception (black).

By classifying on the basis of the specified value range, colors close to white or black, which even a color-sense normal person distinguishes hard, are excluded. Effective numerical values are obtained by experiments as the specified values.

(3) Thresholds to extract red-hue pixel are set.

If an R value (Rn) of a measured pixel n exceeds a threshold (x1) specified for a G value (Gn), and exceeds a threshold (y1) specified for a B value (Bn), the pixel is extracted as a red-hue pixel.

(4) Thresholds to extract green-hue pixels are set.

If the G value (Gn) of the measured pixel n exceeds a threshold (x2) specified for the R value (Rn), and exceeds a threshold (y2) specified for the B value (Bn), the pixel is extracted as a green-hue pixel.

By setting the thresholds as described in (3) and (4), it is possible to handle only colors which are hard to discriminate according to the color sense characteristics.

The processing described in (1) to (4) corresponds to pre-processing.

For example, if a program to be executed by a computer is used, a chromaticity diagram plane, the co-punctual center colors, and the specified values may be stored as specified data items in advance, and the thresholds may be designated as data items set by a user.

(5) R, G, and B values of measured pixel from original image are acquired.

Namely, R, G, and B values of the measured pixel are acquired from the original image.

When the original image is acquired by means of a digital camera or the like, an image processing section has applied the y correction to data of R, G, and B values of the original image according to the device. It is thus necessary to carry out pre-processing to eliminate the y correction applied to the R, G, and B values of the acquired original image.

Subsequently, measurement and processing are carried out for the respective pixels.

(6) Whether measured pixel is within the ranges determined by the specified values are determined.

If the result of the determination is “no”, the pixel is excluded.

(7) Red-Hue pixel is extracted.

(8) Green-Hue pixel is extracted.

(9) Tone value Δn of gray scale for measured pixel is obtained.

For the red-hue pixel, Rn is designated as a tone value.

For the green-hue pixel, Gn is designated as a tone value.

(10) All the pixels ponstituting original image according to (5) to (9) are processed.

As a result of the above processing, the gray scales for the red-hue pixels and the green-hue pixels are created, and all the pixels are classified into the pixels constituting the gray scales or the exceptional pixels.

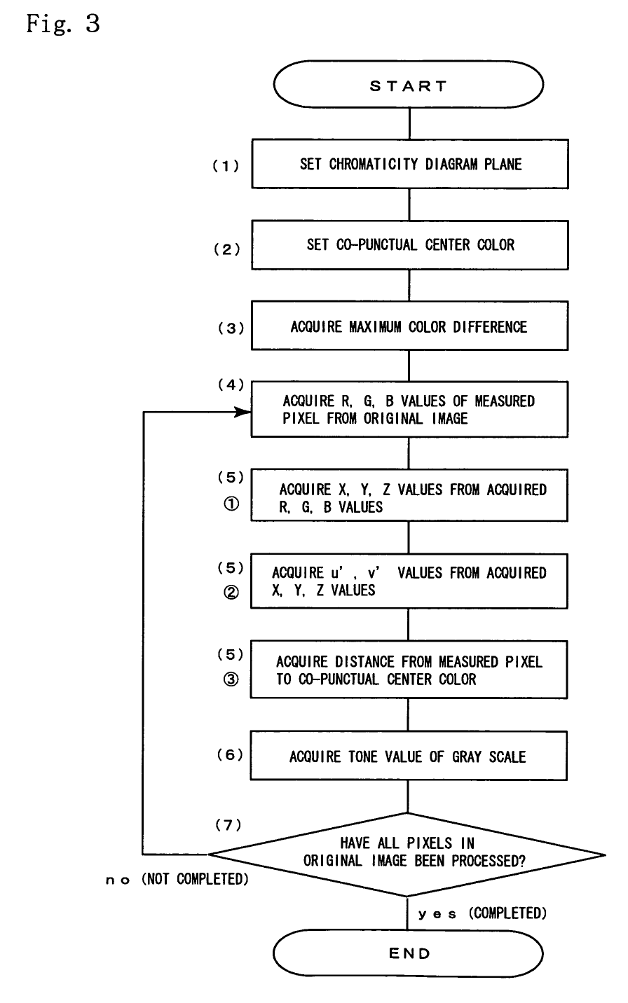

B. Utilizing Chromaticity Diagram Plane (FIG. 3)

(1) Chromaticity diagram plane is set.

Although chromaticity diagrams include the xy chromaticity diagram, the u′v′ chromaticity diagram, and the a*b* chromaticity diagram, the u′v′ chromaticity diagram is preferably used. This is because the u′v′ chromaticity diagram is close to the color sense of the human.

Upon the u′v′ chromaticity diagram plane is then drawn a maximum display area.

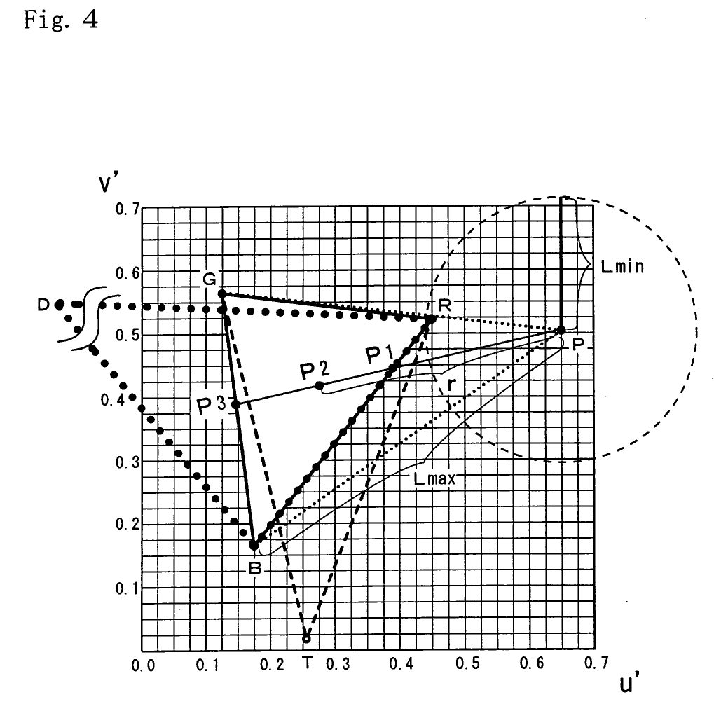

It should be noted that the maximum display area varies according to a device to be used. For example, for the same brightness, the maximum display area is narrower for a displayed image upon a display device than in a print such as a photograph, and further, the maximum display area is narrower upon a CRT and an LCD as the display device. The u′v′ chromaticity diagram in FIG. 4 shows a maximum display area for R, G, and B of a display device for a computer.

(2) Co-punctual center color selected from fixed points P, D, and T respectively referred to as co-punctual point according to type of color-sense abnormality is set.

For the protan, the co-punctual center color is the fixed point P, for the deutan, the co-punctual center color is the fixed point D, and for the tritan, the co-punctual center color is the fixed point T.

(3) Maximum color difference with respect to co-punctual center color is acquired.

The minimum distance (Lₘᵢₙ) and the maximum distance (Lₘₐₓ) from the co-punctual center color to the maximum display area drawn in (1) are acquired, and there is then defined the maximum color difference Δmax=(Lₘₐₓ−Lₘᵢₙ).

For the protan, the distances are obtained in the PGB space.

Lₘᵢₙ: Distance between P and R

Lₘₐₓ: Distance between P and B

For the deutan, the distances are obtained in the RDB space.

Lₘᵢₙ: Distance between D and G

Lₘₐₓ: Distance between D and R

For the tritan, the distances are obtained in the RGT space.

Lₘᵢₙ: Distance between T and B

Lₘₐₓ: Distance between T and G

Processing described in (1) to (3) corresponds to pre-processing.

For example, if a program to be executed by a computer is used, the chromaticity diagram plane, the co-punctual center colors, and the maximum color differences calculated based thereupon may be stored as specified data items in advance, and the type of the color-sense abnormality may be designated as data item set by a user.

(4) R, G, and B values for respective pixels from original image are acquired.

The acquisition is carried out in a similar manner to the case where the R, G, and B values are used.

(5) Color difference for measured pixel with respect to co-punctual center color is acquired.

The R, G, and B values are assigned to a publicly known conversion matrix to covert into X, Y, and Z values. It should be noted that the X, Y, and Z values are apparently used when the xy chromaticity diagram is used.

RGB→XYZ conversion matrix

$$( \begin{matrix}X \\ Y \\ Z\end{matrix} ) = ( \begin{matrix}p 11 & p 12 & p 13 \\ p 21 & p 22 & p 23 \\ p 31 & p 32 & p 33\end{matrix} ) ( \begin{matrix}R \\ G \\ B\end{matrix} ) * 100 / 255$$

$$X = ( p 11 * R + p 12 * G + p 13 * B ) * 100 / 255$$

$$Y = ( p 21 * R + p 22 * G + p 23 * B ) * 100 / 255$$

$$Z = ( p 31 * R + p 32 * G + p 33 * B ) * 100 / 255$$

(It should be noted that the conversion matrix depends on a device to be used, and is adapted to the device)

Then, the X, Y, and Z values are assigned to publicly known equations to covert into u′ and v′ values. It should be noted that the X, Y, and Z values are used when the xy chromaticity diagram is used.
X, Y, Z→u′, v′
u′=4X/(X+15Y+3Z)
v′=9Y/(X+15Y+3Z)

Then, for the protan, the color difference of the color of the measured pixel with respect to the co-punctual center color is defined by a distance r from the fixed point P to the measured pixel, and the distance is acquired. As shown in FIG. 4, the distance of a measured pixel n is represented as rₙ.

It should be noted that the color differences for the tritan and the deutan are respectively defined as a distance between the measured pixel and the fixed point T, and a distance between the measured pixel and the fixed point D.

(6) Gray scale tone value Δn for measured pixel with respect to the maximum display area is acquired.

When a tone value is to be obtained with respect to the maximum display area, the gray scale value is represented as follows when the distance of the measured pixel n is represented as rₙ.

(a) If color close to co-punctual center color is represented as white
Δn=(Lₘₐₓ−rₙ)/Δmax×355
(a) If color far from co-punctual center color is represented as white
Δn=(rₙ−Lₘᵢₙ)/Δmax×255
It should be noted that the tones (256) of the full-color generally used for a display upon a display device for computers is employed in the above equations.

(7) All pixels constituting original image according to (4) to (6) are processed.

As a result of the above processing, the gray scale is created.

A description will now be given of the display process.

A. Utilizing Display Device or Printer for Computers

(1) Still gray scale image or still gradation image of similar color based upon gray scales is created and displayed.

When a gray scale image is created, R, G, and B tone values for a gray scale tone value (X) are represented as (X, X, X).

The gradation image of a similar color is created by reassigning to a distinguishable color based upon the tone value (X) of the gray scale. It is possible to set a color which is selected from colors such as yellow, blue, violet, and cyan, and a user can easily distinguish. For example, since the deutan can distinguish blue, blue can be set.

When the gradation image of a similar color is created, the following conversion is carried out while the gray scale tone value is designated as a base number (X).

Conversion to yellow: (R, G, B)=(X, X, 0)

Conversion to blue: (R, G, B)=(0, 0, X)

Conversion to violet: (R, G, B)=(X, 0, X)

Conversion to cyan: (R, G, B)=(0, X, X)

When the gray scales are created based upon the R, G, and B values, it is possible to create the two gray scales.

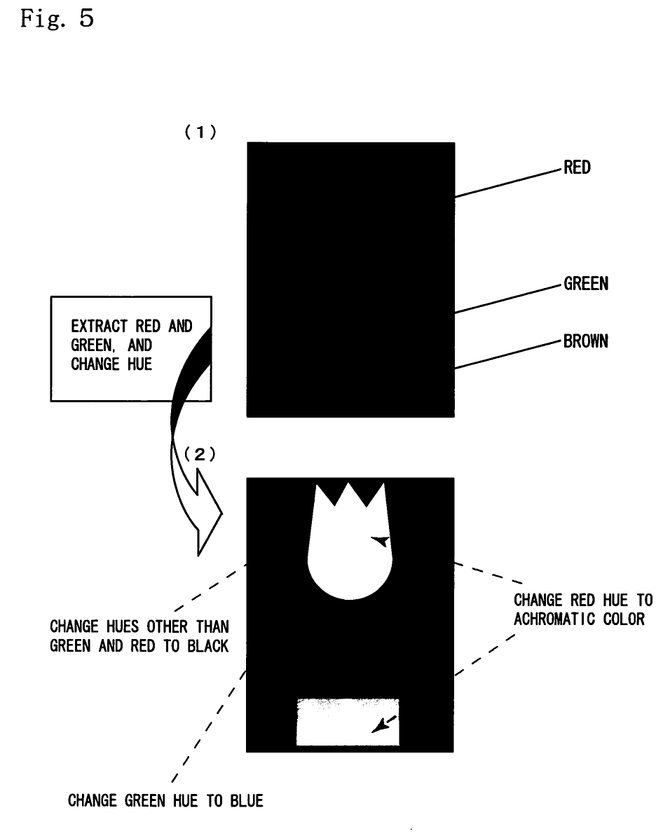

Thus, for example, when there are created respective gray scales for red-hue pixels and green-hue pixels extracted from an original image (color image) shown in FIG. 5(1) according to the above gray scale creating process utilizing the R, G, and B values, the red-hue pixels are assigned to the gray scale (achromatic color), the green-hue pixels are reassigned to blue hues, and the pixels which are excluded are assigned to black, namely, the hues of the pixels are converted, there is obtained a result shown in FIG. 5(2).

(2) Composite image from original image and gray scale image is created, and still image of composite image is displayed.

On this occasion, in order to reduce a sense of discomfort for color-sense normal persons, it is preferable to display a composite image, which has been optimized, in some cases. For example, a warning display which alarms a danger and the like is preferably provided by means of the same one image which does not cause discomfort either for color-sense normal or abnormal persons.

The optimization process can be applied either in the gray scale creating process or the composite image creating process.

For example, if a gray scale is created by means of a chromaticity diagram plane, it is assumed that d denotes a distance from a co-punctual point as a co-punctual center color set upon the chromaticity diagram plane to the color of a selected pixel. If d is converted into a gray scale ranging from 0 to 255, a conversion function f(d) of d to be used may be either a liner function or a generally monotonic non-linear function. Moreover, the conversion function of d may change according to the brightness Y of an object color, namely may be represented as f(d, Y). It should be noted that the minimum value and the maximum value of the conversion function may not be 0 and 255, and may be 0≦min[f(d) or f(d, y)]<max[f(d) or f(d, y)]≦255.

On this occasion, the optimization can be carried out by experimentally setting a more effective function as the conversion function.

Moreover, the composite image is created by synthesizing the original image and the gray scale image or the gradation image pixel-wise in a predetermined pattern, and the optimization can be carried out by experimentally setting a more effective pattern as the pattern. By carrying out the optimization in this way, it is possible to bring an image which color-sense abnormal persons can distinguish closer to an original image, and to reduce the sense of discomfort for the color-sense abnormal persons.

The following practical examples are conceivable.

As a first example, the created gray scale image is binarized by means of a pseudo halftone display technique, and pixels set to one of the two values are replaced by pixels at the same positions in the original image. The composite image created by means of this method is defined as a superimposed composite image.

When the gray scale image is binarized by the pseudo halftone display technique, the error diffusion method or the dither method may be used as the pseudo halftone display technique.

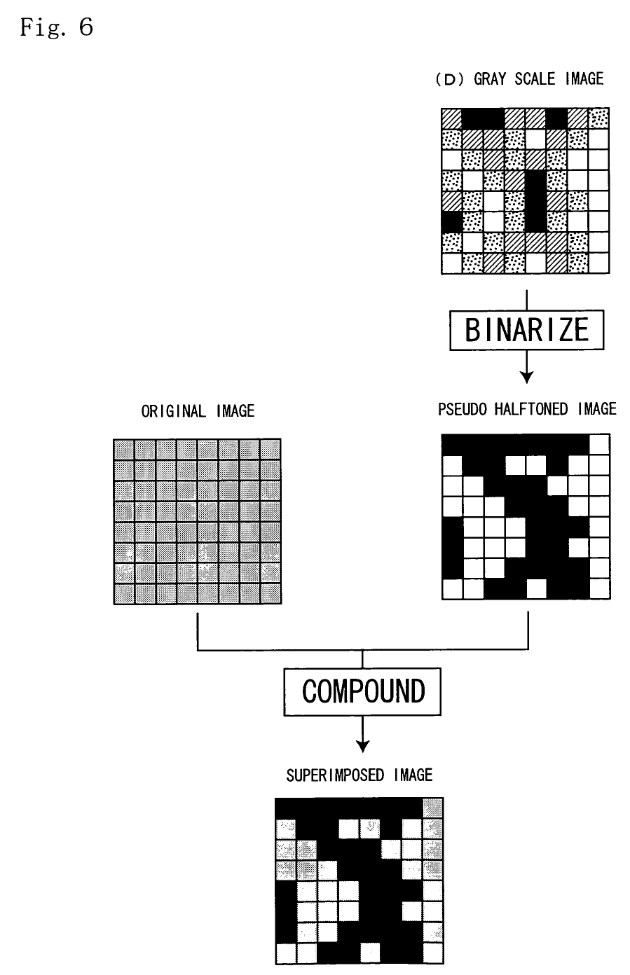

FIG. 6 shows an example where a (D) gray scale image is binarized by means of the error diffusion method to produce a binarized image constituted by all pixels either in black or white, and the pixels in white are replaced by pixels at the same positions as them in the original image.

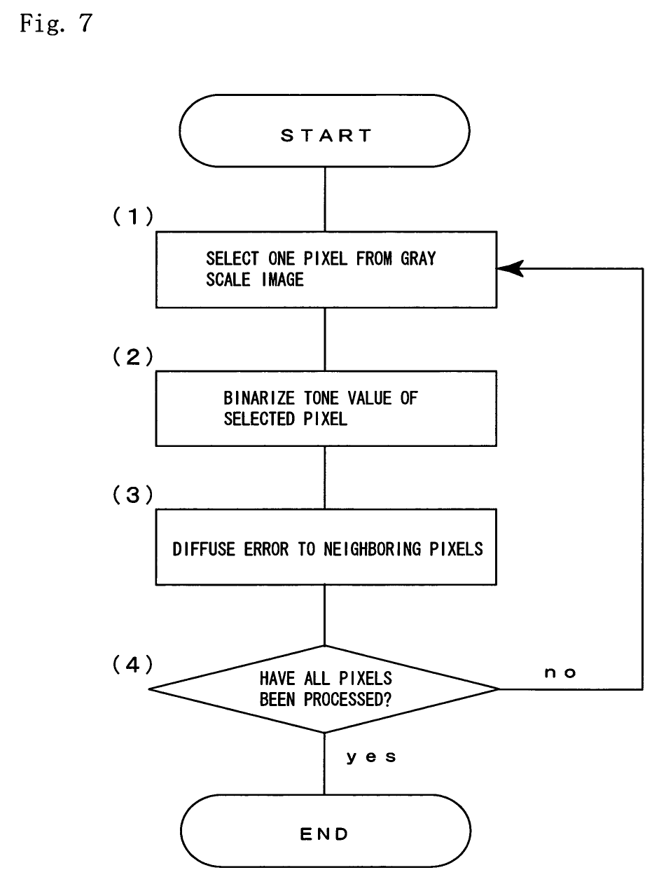

A description will now be given of a procedure of the binarization process by means of the error diffusion method (FIG. 7).

(1) One pixel constituting created gray scale image is selected.

(2) Tone value of selected pixel is binarized.

For example, if the tone value is within a range from 0 to 127, the value is set to 0, and if the tone value is within a range from 128 to 255, the value is set to 255.

(3) Error generated by conversion to neighboring pixels by existing diffusion method is diffused.

(4) Whether all pixels have been processed, and completed binarization process upon completion are determined.

As a second example, the pixels constituting the original image (color image) are replaced by pixels at the same positions in the gray scale image according to a checkered pattern. The composite image created by means of this method is defined as a checkered-pattern composite image.

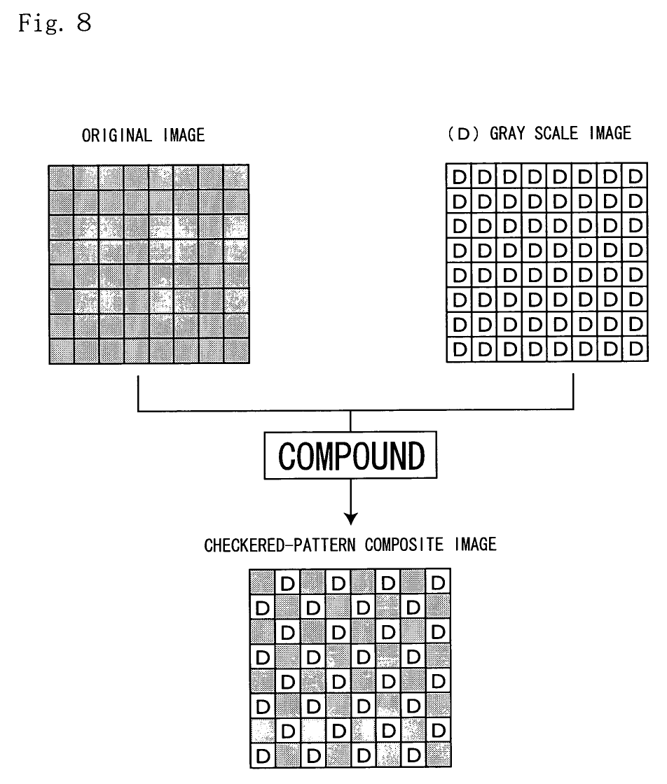

FIG. 8 shows an example where the pixels constituting the original image are replaced by the pixels at the same positions in the (D) gray scale image according to a checkered pattern.

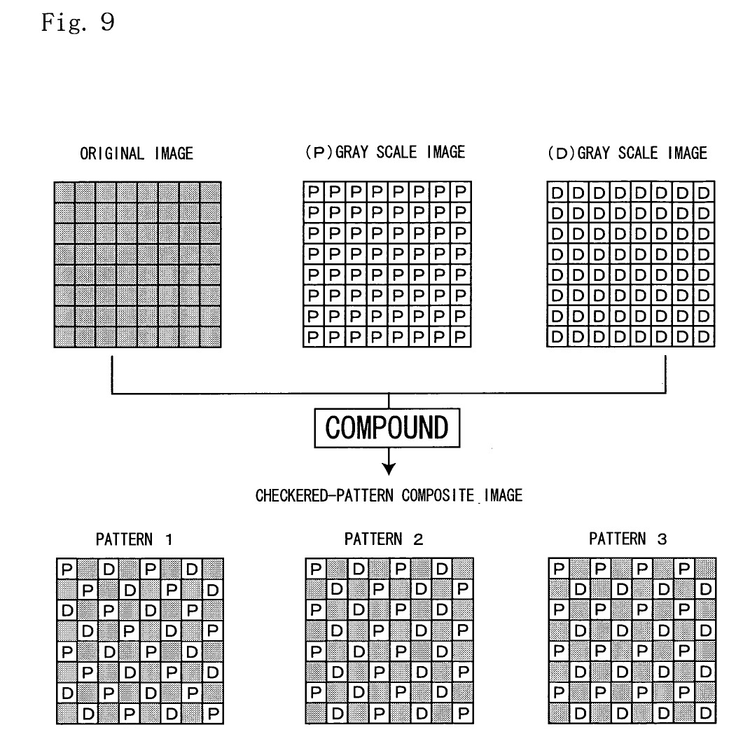

FIG. 9 shows examples where the pixels constituting the original image are replaced by the pixels at the same positions in the (D) gray scale image or a CP) gray scale image according to checkered patterns. On this occasion, the (D) gray scale image is created by means of the chromaticity diagram plane where the fixed point D is considered as the co-punctual center color for the deutan, and the (P) gray scale image is created by means of the chromaticity diagram plane where the fixed point P is considered as the co-punctual center color for the protan.

By the replacements shown in FIG. 9, there are created composite images which both the protan and deutan can recognize.

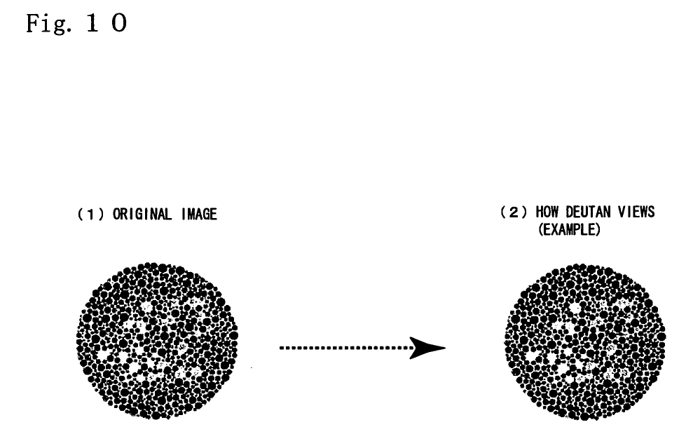

FIG. 10(1) is an Ishihara color blind test plate as an original image (color image), and FIG. 10(2) is an example of how the deutan views.

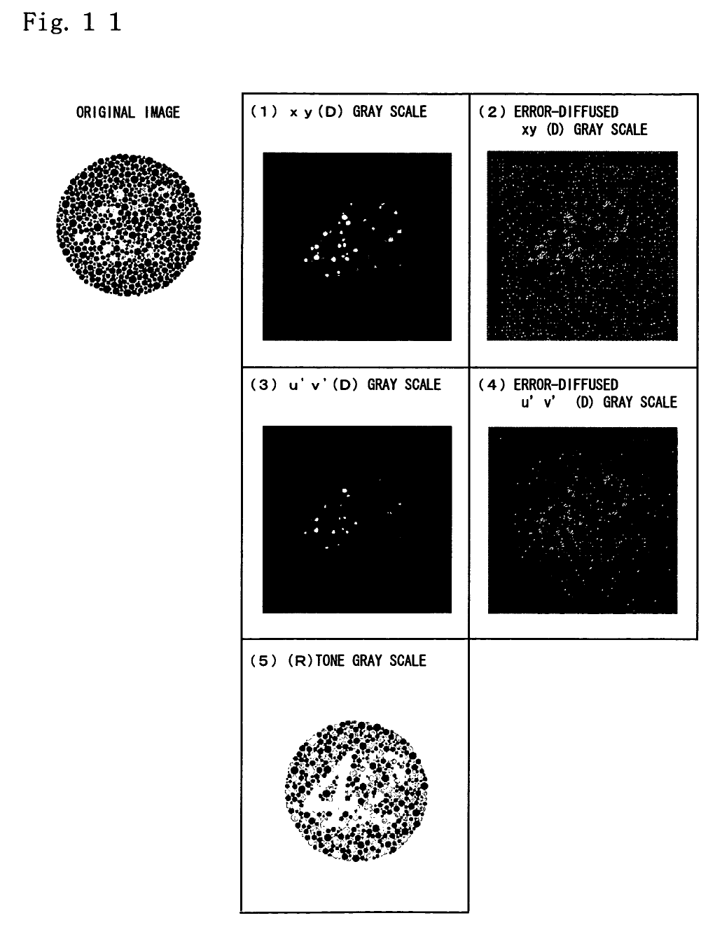

FIG. 11 shows various gray scale images created from FIG. 10(1) as an original image for comparison.

FIG. 11(1) is a (D) gray scale image created by means of an xy chromaticity diagram plane, and FIG. 11(2) shows an error-diffused gray scale image obtained by further binarizing the image in FIG. 11(1) by means of the error diffusion method.

FIG. 11(3) is a (D) gray scale image created by means of a u′v′ chromaticity diagram plane, and FIG. 11(4) shows a gray error-diffused image obtained by further binarizing the image in FIG. 11(3) by means of the error diffusion method.

The (D) gray scale image implies a gray scale image created by using the chromaticity diagram plane where the fixed point D as the co-punctual center color for the deutan.

FIG. 11(5) shows an (R) gray scale image which is crated by means of R values of R, G, and B values.

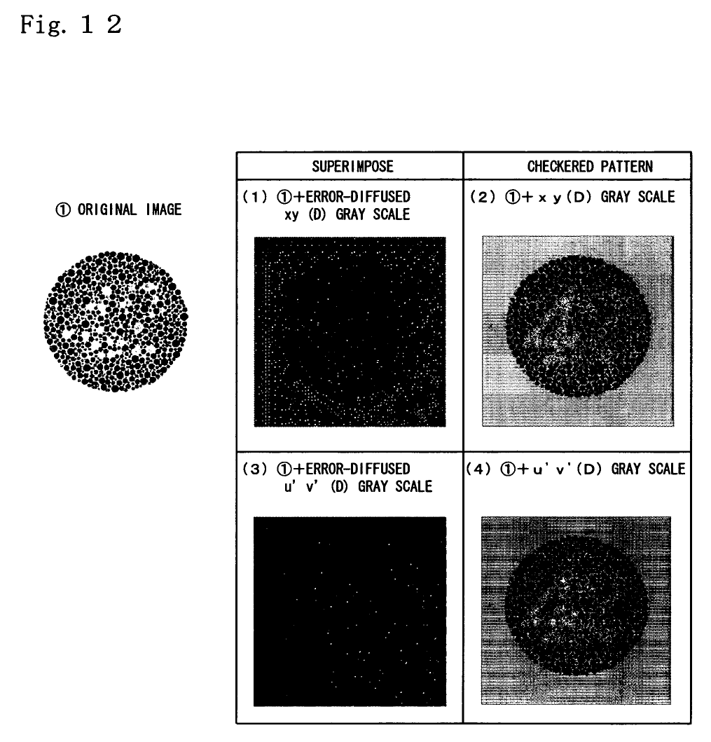

FIG. 12 shows composite images created by applying the above procedure to the original image in FIG. 10(1) for comparison. FIG. 12(1) shows a superimposed composite image of FIG. 11(2), FIG. 12(2) shows a checkered-pattern composite image of FIG. 11(1), FIG. 12(3) is a superimposed composite image of FIG. 11(4), and FIG. 12(4) is a checkered-pattern composite image of FIG. 11(3).

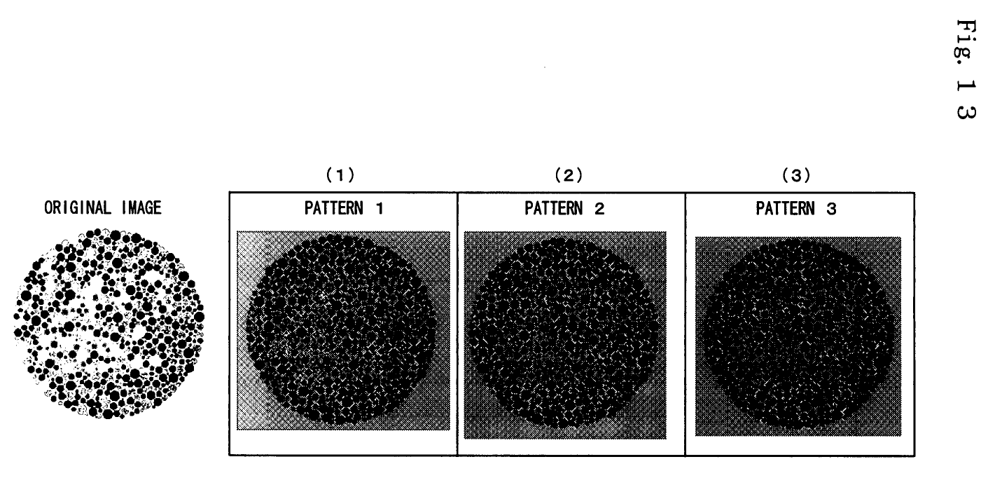

FIG. 13 shows composite images created by applying the procedure in FIG. 9 to the original image in FIG. 10(1) for comparison. FIG. 13(1) shows a composite image in the pattern 1, FIG. 13(2) shows a composite image in the pattern 2, and FIG. 13(3) shows a composite image in the pattern 3.

B. Utilizing Display Device for Computers

A still image of an original image and a still image of a gradation image are displayed while they are being alternately switched.

Preferably, a gray scale image as the gradation image is displayed while being alternately switched.

When the switching display at a high speed (a flash display) is carried out, it is experimentally proved that a location of a color which cannot be distinguished is easily recognized, in other words, sensuously viewed well, due to the after image effect. For example, if a still image of the original image in FIG. 10(1) and a still image of any of the gray scale images in FIG. 11(1), 11(3), and 11(5) are displayed while being switched at a high speed, white portions remains as after images, the deutan can see red portions (namely a number “2”) as if they were raised.

The above creating methods and display method are embodied by a portable phone, a PDA, a wearable PC, and the like, for example.

A description will now be given of an embodying method using a camera-equipped portable phone 1 as an example.

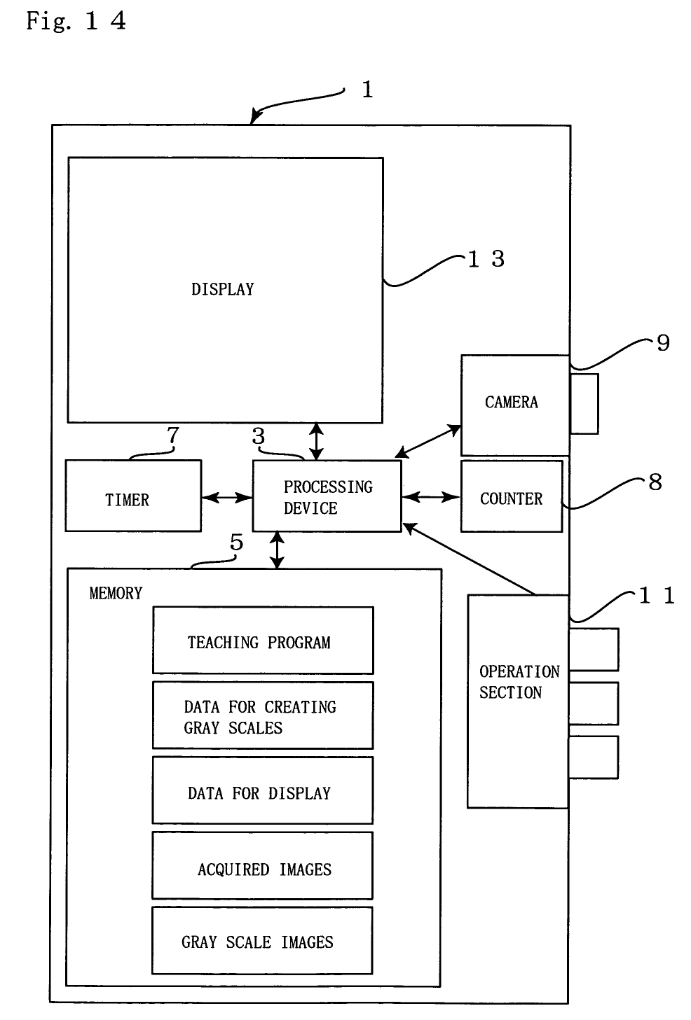

Hardware of the camera-equipped portable phone 1 shown in FIG. 14 is constituted by a processing device 3 which reads out a program to carry out data processing and control, a memory (RAM and ROM) 5 which stores the program and data, a timer 7, a counter 8, a camera 9, an operation section 11, a display 13, an antenna which transmits and receives radio wave, a transmission/reception section which is connected to the antenna, and controls radio communication, a speaker, a microphone, a sound processing section which is connected to the speaker and the microphone, an image processing section, and a storage section which stores image files and the like. It should be noted that only a minimum hardware configuration which is necessary to execute a color existence teaching program (referred to as “teaching program” hereinafter) for a color-sense abnormal person is shown in FIG. 14.

This teaching program causes the camera-equipped portable phone 1 to execute the original image acquiring process, the gray scale creating process, and the display process, and is stored in the storage section which is not shown.

The teaching program may be acquired from a computer-readable recording medium (such as a CD-ROM) which records the program, or via a communication network.

A device which teaches a color existence for a color-sense abnormal person is realized by causing the hardware configured as described above to execute the teaching program.

As an example of the teaching program, a description will be given of a program which creates the (D) gray scale image, and displays the still image of the original image in FIG. 10(1) and the still image of the gray scale image in FIG. 11(1), 11(3), or 11(5) as a flashing display.

In this case, the memory 5 stores data such as a chromaticity diagram plane if used, a maximum display area for R, G, and B according to the type of the portable phone, a co-punctual center color (P, D, or T), and the conversion equations to create the gray scale. If the method employing the R, G, and B values (full-color) is utilized, the memory 5 stores data such as co-punctual center colors (one or two colors of R, G, and B), specified values, the equations for discrimination according to the specified values, and the equations for discrimination according to thresholds which are set in one. The thresholds and the like may be designated as items set by a user.

Moreover, for the flash display, the processing device 3 displays the original image and the gray scale image while switching between them at a high speed based upon information from the timer 7, there are thus also stored data of a display period of the respective images, and data of the number of times to display the gray scale image, namely the number of times for the flash display, and the number of times for the flash display may be designated an item set by the user.

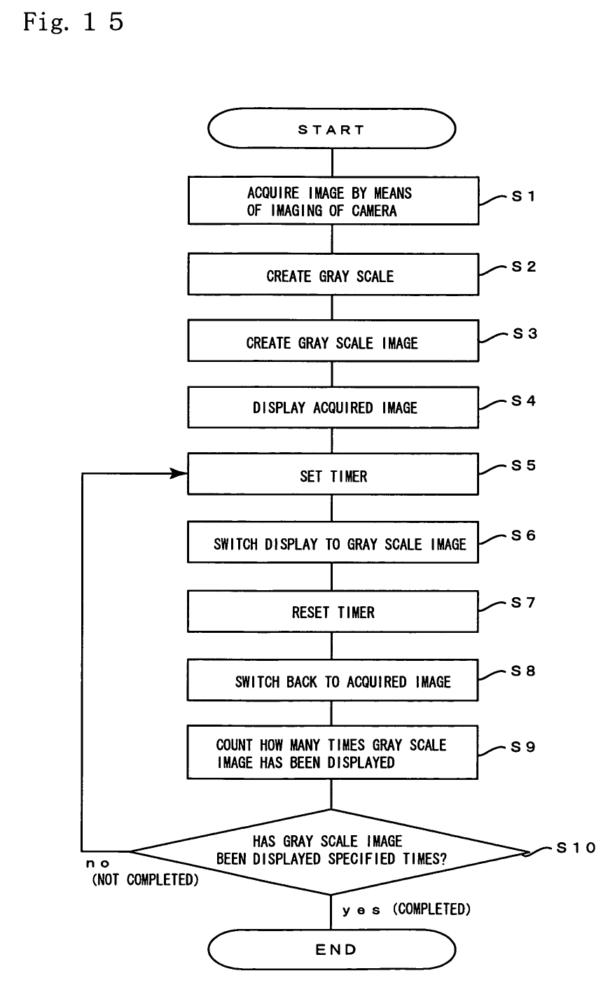

When the teaching program is started, the processing device 3 carries out processing according to steps in FIG. 15.

It should be noted that the items set by the user are displayed as buttons upon the display 13, and are configured so as to be set arbitrarily by the user.

In the original image acquiring process, when a shutter of the camera 9 is depressed, an image acquired by the camera 9 is stored as an original image upon the memory 5 (step Si).

In the gray scale creating process, the processing device 3 creates a gray scale from the original image taken upon the memory 5 according to any of the above creating methods (step S2).

In the display process, the processing device 3 creates a still image of a gray scale image from the gray scale, and stores the still image upon the memory 5 (step S3).

The flash display then starts. First, a still image of the taken image as the original image is displayed (step S4), and the timer 7 is set (step S5). After a specified period (assuming 1/30 second or less) has elapsed, the display is switched to the gray scale image (step S6), and the timer 7 is reset (step S7). Then, the display is switched again to the still image of the original image after the specified period has elapsed (step S8). Then, each time the display of the gray scale image is completed, the counter 8 is incremented by one (step S9).

If the count is smaller than the number of times of the switching display set in advance, the program returns to the step S5, and continues the flash display, and if the count is equal to or larger than the number of times of the switching display, the program finishes the processing while the still image of the original image is being displayed (step S10).

The embodiment of the present invention has been detailed, the specific configuration is not limited to the embodiment, and the present invention includes design changes and the like within the scope which does not change the gist of the present invention.

For example, the original image acquiring process, the gray scale creating process, and the display process are not necessarily carried out by the same device.

Moreover, there may be provided such a configuration that only a portion of an image taken by the camera is selected as an original image by means of a cursor operation or the like.

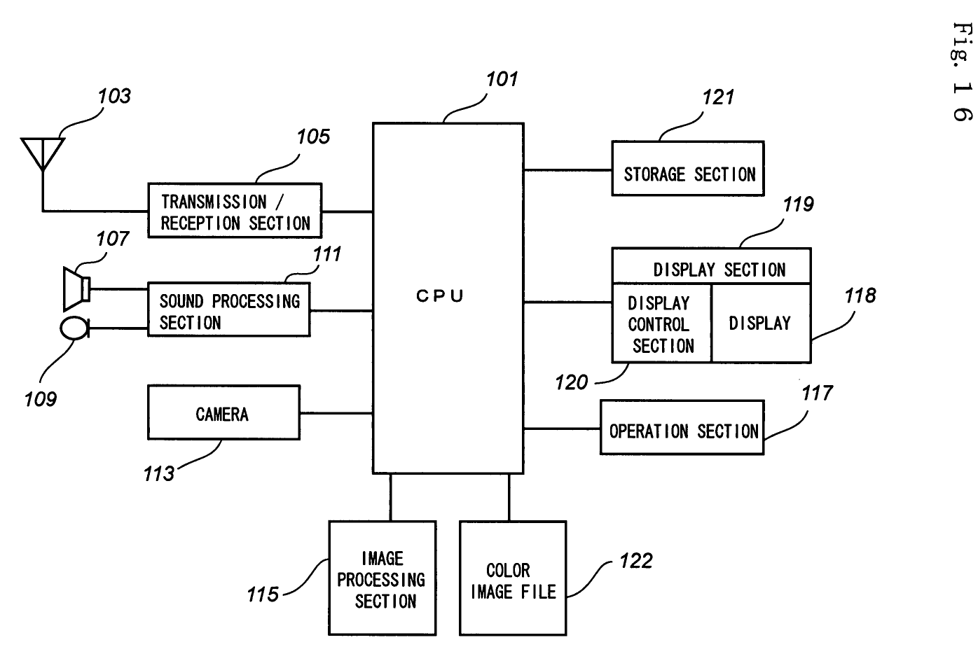

A description will now be given of a color name information acquisition system according to the embodiment of the present invention with reference to FIGS. 16 to 21.

According to the present embodiment, the color name information acquisition system is realized by a camera-equipped portable phone.

FIG. 16 is a block diagram showing a physical configuration of the camera-equipped portable phone which can realize the color name information acquisition system.

As FIG. 16 shows, the color name information acquisition system is constituted by a CPU (control section) 101 which is provided with a work memory, and controls the entire system, an antenna 103 which transmits/receives radio wave, a transmission/reception section 105 which is connected to the antenna 103, and controls radio communication, a speaker 107, a microphone 109, a sound processing section 111 which is connected to the speaker 107 and the microphone 109, a camera 113, an image processing section 115, an operation section 117, a display section 119 which is provided with a display 118 and a display control section 120, and a storage section 121 which stores programs and data.

It should be noted that this portable phone is configured so that it can be connected to the Internet communication network.

A program and data used to realize the color name information acquisition system according to the present embodiment are stored in the storage section 121, and may be initially stored, or may be subsequently stored by means of a download from a WWW server, not shown.

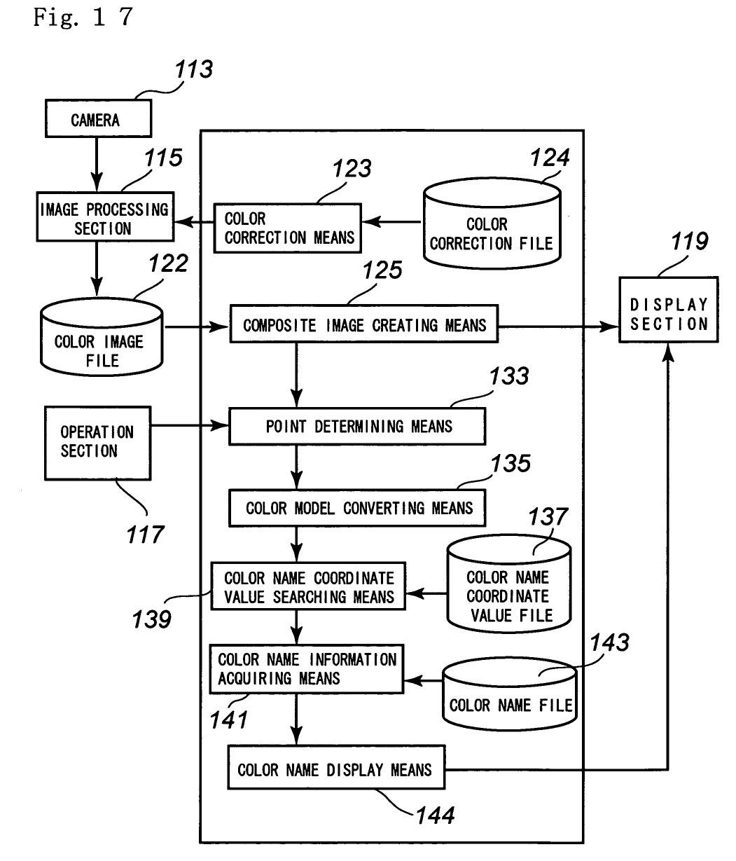

Programs and data used to realize respective means of the color name information acquisition system are stored in the storage section 121. FIG. 17 is a block diagram showing a logical configuration of the color name information acquisition system.

A description will now be given of the color name information acquisition system during logical processing. When an image is acquired by the camera 113, and a video signal is transmitted to an image processing section 115, color image data in a digital form are output, and, on this occasion, color correction means 123 is activated to reads out a color correction file 124 storing color correction data specific to respective portable phones, and applies a color correction to the color image data. The image processing section 115 thus outputs color-corrected color image data. The color-corrected color image is then stored as data for the respective pixels (RGB values of the RGB color model, but are sRGB values) in a color image file 122 in the storage section 121.

The display section 119 reads out the color image from the color image file 122, and inputs. On this occasion, composite image creating means 125 is activated, reads out a mark image stored in advance in the storage section 121, and causes the image processing section 115 to compound a crosshair cursor image as a movable mark and the color image. The display control section 120 of the display section 119 creates a display screen following a predetermined editing format, and the display 118 displays the display screen of the composite image of the color image and the cursor image.

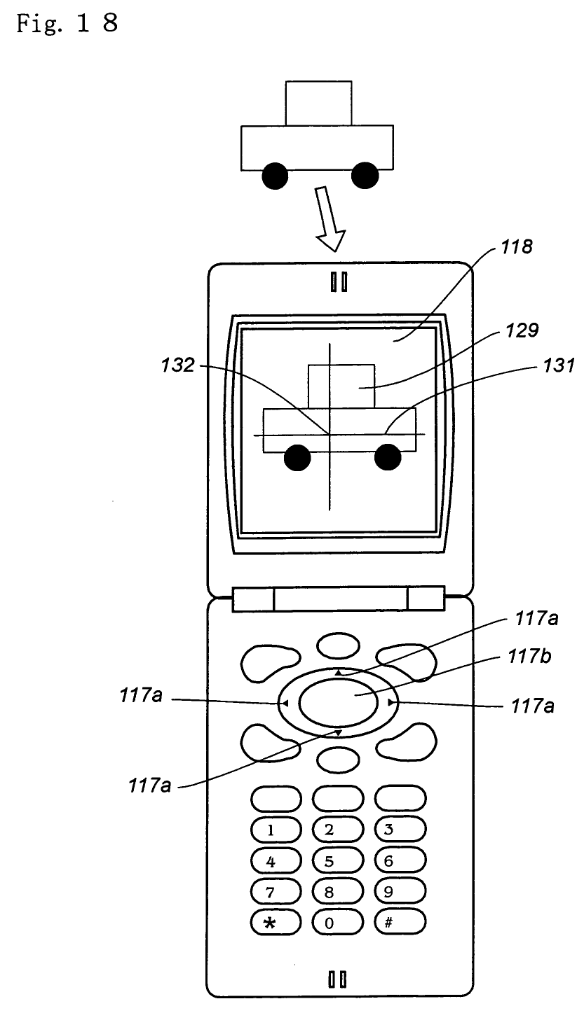

FIG. 18 is an example of the display screen of the composite image. In FIG. 18, reference numeral 129 denotes a color image of an automobile, and reference numeral 131 denotes the crosshair cursor.

A predetermined key (such as 117a) of the operation section 117 is depressed to move a cross display point 132 of the crosshair cursor, a predetermined key (such as 117b) is depressed when the cross display point 132 is at a desired position, and a position specification signal is then output. When the position specification signal is detected, position determining means 133 is activated to specify the cross display point 132 (one pixel) of the crosshair cursor 131 as “point of interesting color name”. When the one pixel is specified as “point of interesting color name”, color model converting means 135 is activated to read out a color image file 122 corresponding to the point from the storage section 121. Then, according to conversion equations stored in advance in a data file, which is not shown, from values thereof are calculated XYZ tristimulus values, and then coordinate values in a uniform color space. As the uniform color space, there are two types: CIE LAB and CIE LUV as defined in JIS Z8729: 1994 “Color specification—CIE LAB and CIE LUV color spaces”, the former is global while the latter is local, and the CIE LAB is thus suitable for search for a color name.

Thus, coordinate values in the CIE LAB color space are calculated according to the present embodiment.

The sRGB values are converted into the XYZ tristimulus values according to the sRGB standard (Equation (7) in “5.3 Transformation from CIE 1931 XYZ values to RGB values”, multimedia systems and equipment-Colour measurement and management INTERNATIONAL STANDARD, IEC 61966-2-1, FIRST EDITION 1999-10).

Then, the XYZ tristimulus values are converted into an L* value, an a* value, and a b* value according to the following conversion equations.
L*=116(Y/Y₀)^{1/3}−16(Y/Y₀>0.008856)
a*=500(X/X₀)^{1/3}−(Y/Y₀)^{1/3}
b*=200(Y/Y₀)^{1/3}−(Z/Z₀)^{1/3}
(In the above equations, there are used standard coefficients: X₀=98.072, Y_{0=100,} and Z₀=118.255)

The obtained L* value, a* value, and b* value are calculated coordinate values.

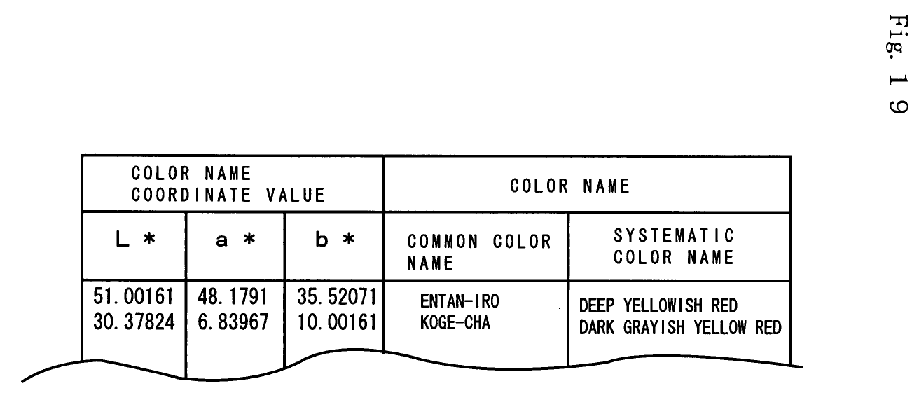

FIG. 19 shows contents of a color name coordinate value file 137 to which coordinate values in the uniform color space (CIE LAB) and corresponding color name display data are registered. As the color names, there are used common color names and systematic color names defined by JIS 8102: 2991 “Name of non-luminous object colors”. The common color name is an individual name of a color such as “toki-iro”. Therefore, if one does not know a color name and a color thereof, one cannot guess the color at all. On the other hand, the systematic color name represents a color by combining a basic color name (red, yellow red (orange), yellow, yellow green, . . . ) with modifiers relating to the lightness/saturation (vivid, bright, dark, light, . . . ) and modifiers relating to the hue (reddish, yellowish, . . . ).

The calculated coordinate values do not always match the color name coordinate values registered to the color name coordinate value file 137.

Thus, there is searched for a color name to which the color name coordinate values are approximated.

Color name coordinate value searching means 139 is activated, and searches for color name coordinate values to which the distance is shortest in the uniform color space by means of a linear search method. In the uniform color space, a distance corresponds to a color difference, and it is thus possible to obtain a proper color name by means of a simple search method even if limited color names are stored.

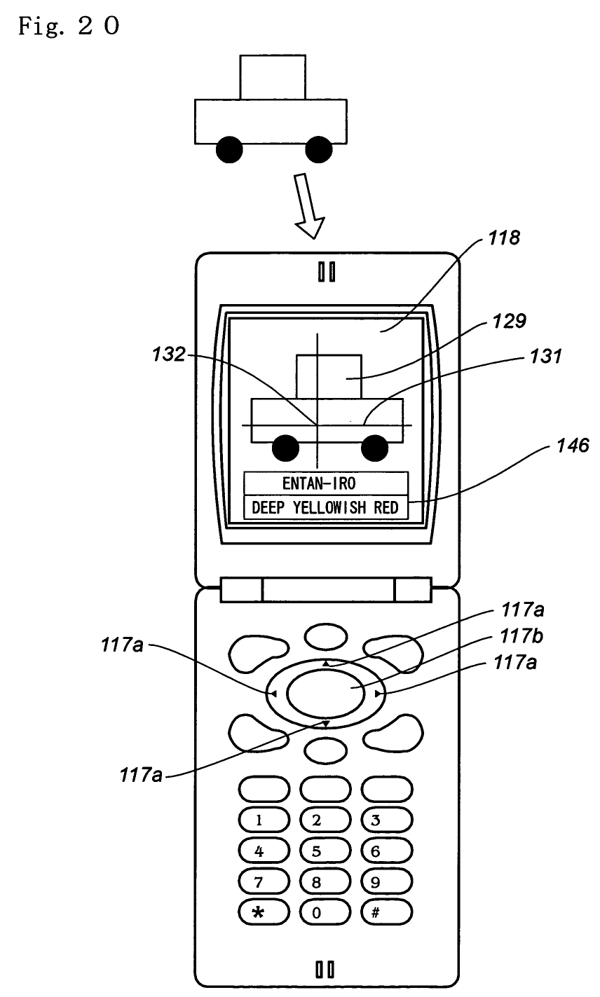

When the search for the color name coordinate values is finished, and desired color name coordinate values are obtained, color name information acquiring means 141 is activated to read in a color name file 143, and to read out a display screen data for “color name”. Moreover, color name display means 144 is activated to cause the display control section 120 of the display section 119 to create a color name display sub-screen 146 used to visually teach “color name” corresponding to the searched color name coordinate values (L* value, a* value, b* value). As a result, the display 118 shows “color name”. FIG. 20 shows a screen simultaneously displaying two color names: a common color name “entan-iro” and a systematic color name “deep yellowish red”.

According to the present embodiment, since the common color name and the systematic color name are displayed simultaneously, it is possible to correctly know a color name which one has not known before.

It should be noted that the description is given of only the major files of files stored in the storage section 121 in the above description of the system.

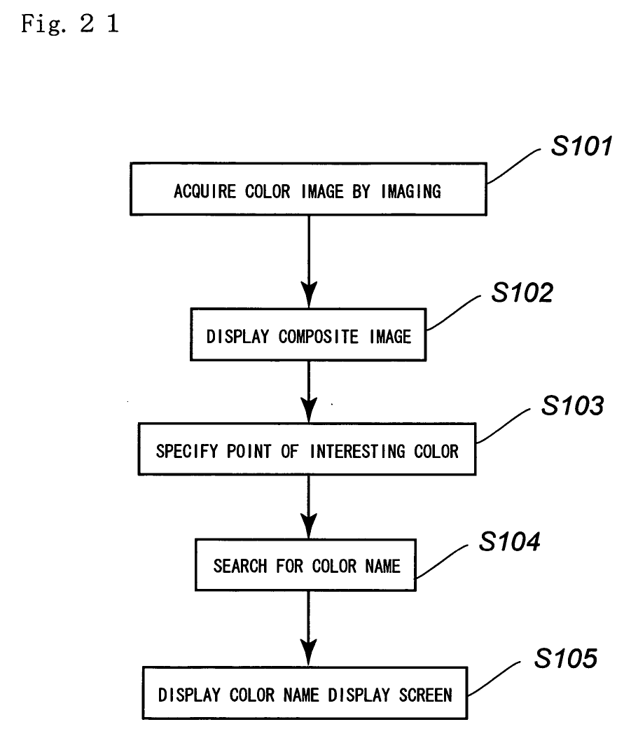

A brief description will now be given of the present embodiment with reference to a processing flowchart shown in FIG. 21.

When the color image is taken by the image pickup with the camera 113 (step S101), the composite image (composite screen) of the color image and the cursor image is shown upon the display 118 as in FIG. 18 (step S102). The display point (pixel) of the cursor image is specified as “point of interesting color name” (step S103), the color name is searched for (step S104), and the color name display screen used to teach the color name at the point is shown on the display 118 (step S105).

The embodiment of the present invention has been detailed, the specific configuration is not limited to that according to the embodiment, and design changes and the like which do not deviate from the gist of the present invention are included within the scope of the present invention.

For example, the camera-equipped portable computer device is not limited to the camera-equipped portable phone which one can carry, and include a PDA and a wearable PC even at the present time.

The camera may be a digital camera or a video camera.

The processing operation is not necessarily carried out entirely by the portable computer device, and the color image may be transmitted to a WWW server, the processing may be carried out by the WWW server, and the color name display screen may be transmitted back, for example.

The color name information acquiring means may create a color name display sound which is used to acoustically teaches the corresponding “color name”, and may provide the sound processing section with the sound.

The color name display screen may be displayed after switching from the display screen of the color image. In this case, the size of the one screen is large, and a zoomed-in image around the mark may also be displayed.

Moreover, there may be displayed a circular color image of the hue H (radial direction) and the saturation S (circumferential direction) of the HSV color model, and predetermined color pixels within the image if necessary.

The embodiment is not limited to the configuration which corresponds “color name” to one pixel, and, for example, and when a certain pixel is specified, respective three X, Y, and Z coordinate values of the pixel and neighboring pixels may be calculated, average values thereof may be obtained, coordinate values in the uniform color space (CIE LAB) are calculated from the average values, and the color name coordinate values may be searched for based thereupon. Moreover, there may be provided such a configuration that “color name” may be obtained from pixels from the entire screen. In this case, it is not necessary to display the cursor and the like. If there is provided such a configuration, the camera is brought close to an object such as a suit whose color name is of interest in order to acquire the color image thereof.

Moreover, the output (storage) to the color image file may not be carried out, and the processing may be carried out upon the memory within the CPU.

According to the embodiment, although the common color name and the systematic color name are displayed at the same time, only either one of them may be displayed.

Moreover, there may be provided such a configuration that a user can create an own color name file.

The specification process may be configured so as not to require the operation upon the operation section 117 in the step S103. For example, when the cursor is superimposed upon the color image, there may be provided such a configuration that the program processes the position of the cursor as a specified point of an interesting color name.

Moreover, the stage to acquire the image in the step S101 may be eliminated, there may be added a function which displays a color name at a center position to functions of the CCD camera, and the color name may be obtained simply by directing the camera to an object.

### INDUSTRIAL APPLICABILITY

Since the method for teaching a color existence for a color-sense abnormal person according to the present invention can be executed by a device such as a portable phone, the color-sense abnormal person can distinguish a color without being recognized by other persons around. Various information are often displayed by means of combinations of colors in the modern society, and it is thus expected that the teaching method executed by the device such as the portable phone serves as a useful color sense assisting tool which the color-sense abnormal person can freely use without caring other persons around.

Since the color name information acquisition method according to the present invention can be executed by a device such as a portable phone, the color-sense abnormal person can know a color name on the spot without being recognized by other persons. Moreover, if there is provided the color name teaching means by means of sounds, a congenital color-sense abnormal person can know existences of colors around, which the person could not know otherwise in the lifetime, by means of sounds.

1. (canceled)

2. A method for teaching a color existence for a color-sense abnormal person, comprising:
a gray scale creating step of setting a color which a color-sense abnormal person tends to confuse or a co-punctual point to a co-punctual center color, defining a degree of confusion as a color difference between a color of each pixel of an original image and the co-punctual center color, and converting the color to a gray scale tone value which corresponds to the color difference, and is distinguished by the color-sense abnormal person; and
a display step of creating and displaying a gray scale image or a gradation image of a similar color based upon the created gray scale.

3. The method for teaching a color existence for a color-sense abnormal person according to claim 2, said gray scale creating step uses RGB values, sets any of the R value, the G value, and the B value as the co-punctual center color, and sets the gray scale tone value corresponding to the color difference in the RGB value between the pixel and the set co-punctual center color.

4. The method for teaching a color existence for a color-sense abnormal person according to claim 2, wherein said gray scale creating step uses a chromaticity diagram plane, sets any of fixed points P, D, and T of co-punctual points as the co-punctual center color, and sets a distance from the set co-punctual center color to the color of the pixel in the original image as the color difference.

5. The method for teaching a color existence for a color-sense abnormal person according to claim 4, wherein in that said gray scale creating step creates the gray scale for the tone value on the basis of a maximum display area of R, G, and B of the chromaticity diagram corresponding to a device to be used.

6. The method for teaching a color existence for a color-sense abnormal person according to claim 2, wherein in that said display step compounds the original image and the gray scale image or the gradation image into a predetermined pattern for the respective pixels, and displays a composite image.

7. The method for teaching a color existence for a color-sense abnormal person according to claim 6, wherein in that the display is carried out as a composite image to which optimization is applied in order to reduce a sense of discomfort for a color-sense normal person.

8. The method for teaching a color existence for a color-sense abnormal person according to claim 7, wherein in that the created gray scale is binarized by means of a pseudo halftone display technique, and the display is carried out as the composite image to which the optimization is applied by replacing a pixel of either of the values with a pixel in the original image at the same position.

9. The method for teaching a color existence for a color-sense abnormal person according to claim 2, wherein in that said display step carries out the display as a still image.

10. The method for teaching a color existence for a color-sense abnormal person according to claim 2, wherein in that said display step uses a display, and carries out a flash display of the gray scale image or the gradation image of the similar color while the original image is being displayed.

11. A program for teaching a color existence for a color-sense abnormal person causing a computer to execute the gray scale creating step and the display step according to claim 2.

12. The program for teaching a color existence for a color-sense abnormal person according to claim 11, wherein in that the computer is a camera-equipped portable terminal, and is caused to execute an original image acquiring step of acquiring the original image by means of imaging using a camera.

13-20. (canceled)
